(19) United States
(12) Patent Application Publication
(10) Pub. No.: US 2026/0149175 A1
(43) Pub. Date: May 28, 2026

(54) PHASE SHIFTING SYSTEM FOR ANTENNAS

(71) Applicant: OUTDOOR WIRELESS NETWORKS LLC, Richardson, TX (US)

(72) Inventors: Xiaofeng Wang, Suzhou (CN); Qiang Wang, Suzhou (CN); Ruixin Su, Suzhou (CN); Keyun Di, Suzhou (CN)

(21) Appl. No.: 19/379,032

(22) Filed: Nov. 4, 2025

(30) Foreign Application Priority Data
Nov. 22, 2024 (CN) 202411686197.9

(51) Int. Cl. H01Q 3/32

(52) U.S. Cl. CPC H01Q 3/32

(57) ABSTRACT

A phase shifting system for antennas includes: a plurality of transmission assemblies, each of which has a gear set and a rack that can be driven by the gear set, the gear set having a clutch gear that can switch between a coupled position and a decoupled position, wherein in the coupled position of the clutch gear, the gear set can drive the rack to move, and in the decoupled position of the clutch gear, the rack cannot be driven by the gear set; a plurality of phase shifting transmission elements, each of which is correspondingly disposed to the clutch gear of the plurality of transmission assemblies and can be movably coupled with the clutch gear; and a phase shifting drive mechanism configured to selectively drive any one of the plurality of phase shifting transmission elements, wherein, the driven phase shifting transmission element can drive the clutch gear of the corresponding transmission assembly from the decoupled position to the coupled position.

### RELATED APPLICATION

The present application claims priority from and the benefit of Chinese Patent Application No. 202411686197.9, filed November 22, 2024, the disclosure of which is hereby incorporated herein by reference in full.

### TECHNICAL FIELD

The present disclosure relates to a phase shifting system for antennas.

### BACKGROUND ART

Existing multi-frequency antenna phase shifting mechanisms typically feature a complex overall structure with multiple transmission shaft assemblies arranged in a multi-layer configuration, often exhibiting an annular arrangement structure. This multi-layer arrangement structure results in a relatively high height. Currently, there is an increasing demand for a greater number of antenna devices with adjustable performance to enhance antenna functionality. However, given the limited diameter or installation height of antennas, this multi-layer arrangement structure is not conducive to accommodating a larger number of transmission shaft assemblies.

### SUMMARY OF THE INVENTION

Therefore, the present disclosure aims to provide a phase shifting system for antennas , which can address at least one of the aforementioned technical issues present in the prior art.

According to the present disclosure, a phase shifting system for antennas is provided, characterized in that the phase shifting system comprises: a plurality of transmission assemblies, each of which has a gear set and a rack that can be driven by the gear set, the gear set having a clutch gear that can switch between a coupled position and a decoupled position, wherein in the coupled position of the clutch gear, the gear set can drive the rack to move, and in the decoupled position of the clutch gear, the rack cannot be driven by the gear set; a plurality of phase shifting transmission elements, each of which is correspondingly disposed to the clutch gear of the plurality of transmission assemblies and can be movably coupled with the clutch gear; and a phase shifting drive mechanism configured to selectively drive any one of the plurality of phase shifting transmission elements, wherein, the driven phase shifting transmission element can drive the clutch gear of the corresponding transmission assembly from the decoupled position to the coupled position.

In some examples, the gear set further comprises a driving gear and a driven gear, the driven gear engaging with the rack, wherein, in the coupled position of the clutch gear, the clutch gear engages with the driving gear and the driven gear, and in the decoupled position of the clutch gear, the clutch gear is disengaged from the driving gear and the driven gear.

In some examples, each phase shifting transmission element can push the clutch gear along its axis via its pushing section to move it from the decoupled position to the coupled position. Each clutch gear is provided with a decoupling spring configured to move the clutch gear from the coupled position to the decoupled position by its restoring force.

In some examples, each phase shifting transmission element is provided with a stop tooth, and in the decoupled position of the clutch gear, the stop tooth engages with the teeth of the rack to prohibit the rack from moving.

In some examples, the rack has a toothed section with teeth and an extending section adjacent to the toothed section without teeth, a scale stop is fixed on the extending section of the rack and can move together with the rack.

In some examples, the phase shifting drive mechanism comprises at least one pair of cooperating phase shifting screw and phase shifting nut, the rotation of the phase shifting screw being able to drive the phase shifting nut thereon to move, wherein, the phase shifting nut has a driving protrusion laterally, and each of the plurality of phase shifting transmission elements has a transmission section, the transmission sections being arranged successively in the longitudinal direction of the phase shifting screw such that during the movement of the phase shifting nut, the driving protrusion of the phase shifting nut can successively load the transmission sections of the phase shifting transmission elements and thereby driving the phase shifting transmission elements.

In some examples, each transmission section of the phase shifting transmission elements has a transmission slope and an engagement end face, the driving protrusion being able to move the phase shifting transmission element by pressing the transmission slope, so that the phase shifting transmission element pushes the corresponding clutch gear from the decoupled position to the coupled position, and the driving protrusion can maintain the position of the phase shifting transmission element by abutting against the engagement end face, thereby keeping the clutch gear in the coupled position.

In some examples, each of the plurality of phase shifting transmission elements has a connecting rod section connected to the transmission section, the connecting rod section having a portion extending perpendicular to the longitudinal direction of the phase shifting screw, the portion of the connecting rod section being laterally stopped by a stop.

In some examples, a spring is provided for at least one portion of the connecting rod section of the phase shifting transmission elements, the spring being able to apply a restoring force to the phase shifting transmission element towards the direction of the phase shifting screw when the corresponding phase shifting transmission element is driven.

In some examples, two pairs of phase shifting screws and phase shifting nuts are provided, and the two phase shifting screws are disposed in parallel, wherein a row of transmission assemblies is respectively arranged on the outer sides of the two phase shifting screws, the transmission sections of the two rows of transmission assemblies being arranged successively in the longitudinal direction of one phase shifting screw and being able to be driven by one phase shifting nut respectively.

In some examples, the transmission sections of the two rows of transmission assemblies are arranged successively offset from each other in the longitudinal direction of the phase shifting screw.

In some examples, the two phase shifting screws can be synchronously driven by a phase shifting gear set.

In some examples, a pair of phase shifting screws and phase shifting nuts is provided, a row of transmission assemblies being disposed on one side of the phase shifting screw, the transmission sections of this row of transmission assemblies being arranged successively in the longitudinal direction of the phase shifting screw and being able to be driven by the phase shifting nut.

In some examples, a common drive shaft is provided for all transmission assemblies, the drive shaft serially connecting the driving gears of all transmission assemblies and being able to simultaneously drive all the driving gears to rotate together.

In some examples, the pushing section of each phase shifting transmission element has a connecting pin extending along the axis of the clutch gear, the connecting pin being able to be inserted into a receiving part of a connecting post fixed on the clutch gear, wherein in the coupled position, the clutch gear drives the connecting post to rotate around the connecting pin.

In some examples, the rack is provided with a connecting structure on its extending section, the rack being connected to the antenna device to be adjusted through the connecting structure.

Those skilled in the art will understand the advantages of the respective examples and various other examples by reading the following detailed description of the respective examples with reference to the drawings listed below.

### BRIEF DESCRIPTION OF DRAWINGS

The present disclosure is further illustrated below with reference to the attached drawings and examples, in which:

FIG. 1 shows a schematic perspective view of a phase shifting system for multi-frequency antennas according to a first example of the present disclosure.

FIG. 2 shows a schematic perspective view of one of the transmission assemblies in the phase shifting system of FIG. 1.

FIG. 3 shows a partial view of the other side of the transmission assembly in FIG. 2, where the clutch gear is in the coupled position.

FIG. 4 shows a schematic perspective view of the rack of the transmission assembly in FIG. 2.

FIG. 5 shows a partial view of the other side of the transmission assembly in FIG. 2, where the clutch gear is in the decoupled position and the stop tooth of the phase shifting transmission element is engaged with the teeth of the rack.

FIG. 6 schematically shows the relative position of the clutch gear of the transmission assembly in FIG. 2 with respect to the phase shifting transmission element disposed in the transmission assembly.

FIG. 7 shows a schematic perspective view of the phase shifting transmission element in FIG. 6.

FIG. 8 schematically shows a perspective view of the relative position of the phase shifting transmission element with respect to the clutch gear of the transmission assembly and a phase shifting drive mechanism.

FIG. 9 schematically shows a top view of the relative position in FIG. 8.

FIG. 10 schematically shows a partial view of the phase shifting system in FIG. 1.

FIG. 11 shows the state where the first transmission assembly on the left side is activated.

FIG. 12 shows the state where the first transmission assembly on the right side is activated.

FIG. 13 shows a schematic top view of a phase shifting system for multi-frequency antennas according to a second example of the present disclosure.

### Detailed Description of Specific Embodiments

The present disclosure will be described below with reference to the attached drawings, which show several examples of the present disclosure. However, it should be understood that the present disclosure can be presented in many different ways and is not limited to the examples described below. In fact, the examples described below are intended to make the present disclosure more complete and to fully explain the protection scope of the present disclosure to those skilled in the art. It should also be understood that the examples disclosed in the present disclosure may be combined in various ways so as to provide more additional examples.

It should be understood that in all the figures, the same reference numerals denote the same elements. In the attached drawings, the dimensions of certain features can be changed for clarity.

It should be understood that the words in the specification are only used to describe specific examples and are not intended to limit the present disclosure. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The terms “ comprises, ” “ includes, ” and “ containing ” as used in the specification indicate the presence of the claimed features but do not exclude the presence of one or more other features. The term “ and/or ” as used in the specification includes any and all combinations of one or more of the related listed items. The terms “ between X and Y ” and “ between about X and Y ” as used in the specification should be interpreted to include X and Y. As used herein, the wording “ between approximate X and Y” means “between approximate X and approximate Y”, and as used herein, the wording “from approximate X to Y” means “from approximate X to approximate Y”.

In the Specifications, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present. In contrast, if an element is described as “directly” “on” another element, “directly attached” to another element, “directly connected” to another element, “directly coupled” to another element, or “directly in contact with” another element, no intermediate elements are present. In the Specification, a feature that is arranged “adjacent” to another feature, may denote that a feature has a part that overlaps an adjacent feature or a part located above or below the adjacent feature.

In the specification, spatial relationship terms such as “upper,” “lower,” “left,” “right,” “front,” “rear,” “high,” “low,” etc., may describe the relationship of one feature to another as shown in the figures. It should be understood that spatial relationship terms include not only the orientation shown in the figures but also different orientations of the device in use or operation. For example, when the device in the figures is inverted, a feature originally described as “below” another feature may then be described as “above” the other feature. The device can also be oriented in other ways (rotated 90 degrees or in other orientations), and the relative spatial relationships should be interpreted accordingly.

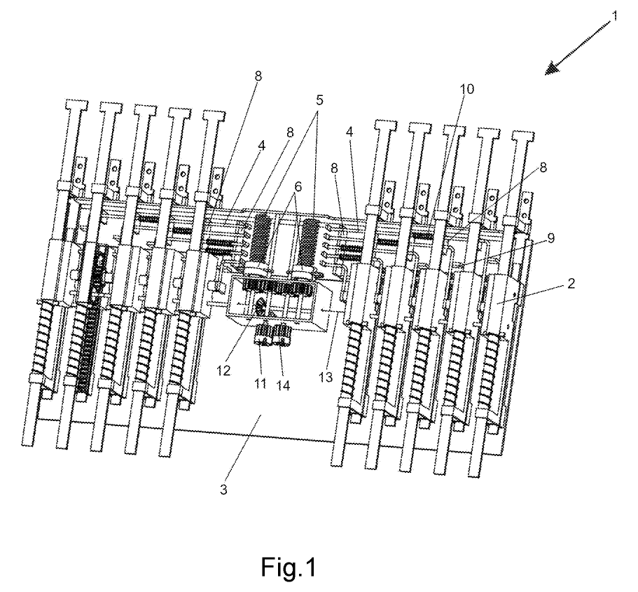

FIG. 1 shows a phase shifting system 1 for antennas, such as a multi-frequency antenna, according to a first example of the present disclosure. The phase shifting system 1 can have multiple transmission assemblies 2, shown herein as 10. These transmission assemblies 2 are disposed in a single-layer tiled arrangement.

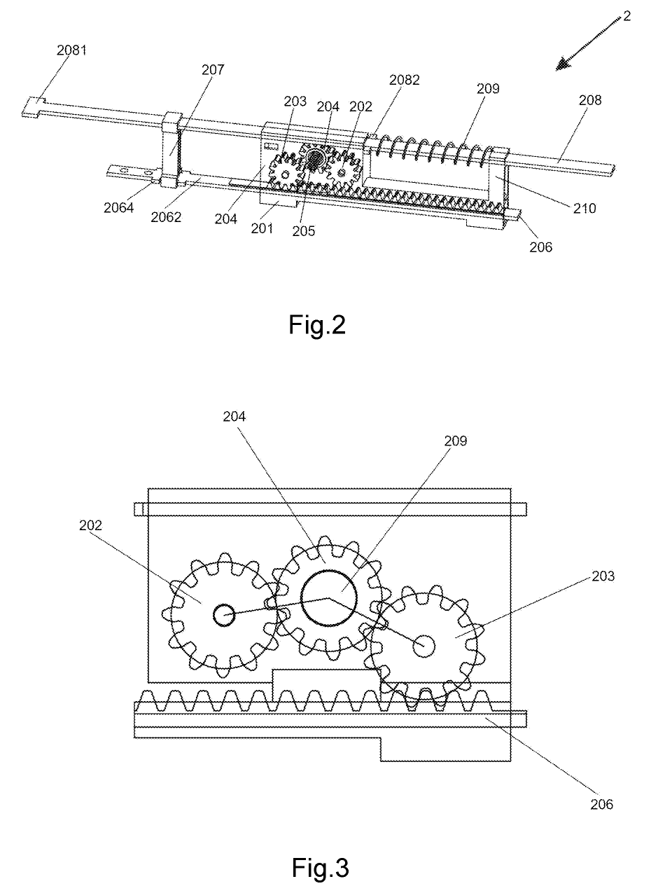

FIG. 2 shows a schematic of one of the transmission assemblies 2. The transmission assembly 2 can have a base 201, which can be used to fix the transmission assembly 2 to a mounting plate 3 of the phase shifting system 1. A gear set may be disposed in the base 201, which can have a driving gear 202, a driven gear 203, and a clutch gear 204 arranged with axes parallel to each other. The driving gear 202 and the driven gear 203 can be axially fixed in the base 201, for example, on the wall 204 of the base 201 (which is made transparent in the figure to show the internal structure), and may be arranged to overlap each other axially, for example, aligned with each other, while being radially spaced apart, i.e., not engaged with each other. The clutch gear 204 can be disposed radially between the driving gear 202 and the driven gear 203 and can move axially between its decoupled position (i.e., initial position) and coupled position. In the coupled position, the clutch gear 204 engages the driving gear 202 and the driven gear 203 in the middle, allowing the driving gear 202 to drive the driven gear 203 to rotate via the clutch gear 204, referring to FIG. 3. In the decoupled position, the clutch gear 204 disengages from the driving gear 202 and the driven gear 203, thereby disengaging the driving gear 202 from the driven gear 203, and the driving gear 202 cannot drive the driven gear 203 to rotate, referring to FIG. 1 and FIG. 5. A decoupling spring 205 cam be disposed between the clutch gear 204 and the wall 204 of the base 201, which can be in a compressed state in the coupled position.

Referring to FIG. 3, the nearly horizontal arrangement of the three gears 202, 203, 204 of the gear set can effectively further reduce the vertical height of the transmission assembly 2 and thus the entire phase shifting system 1, even though these transmission assemblies 2 already have a single-layer arrangement with reduced height.

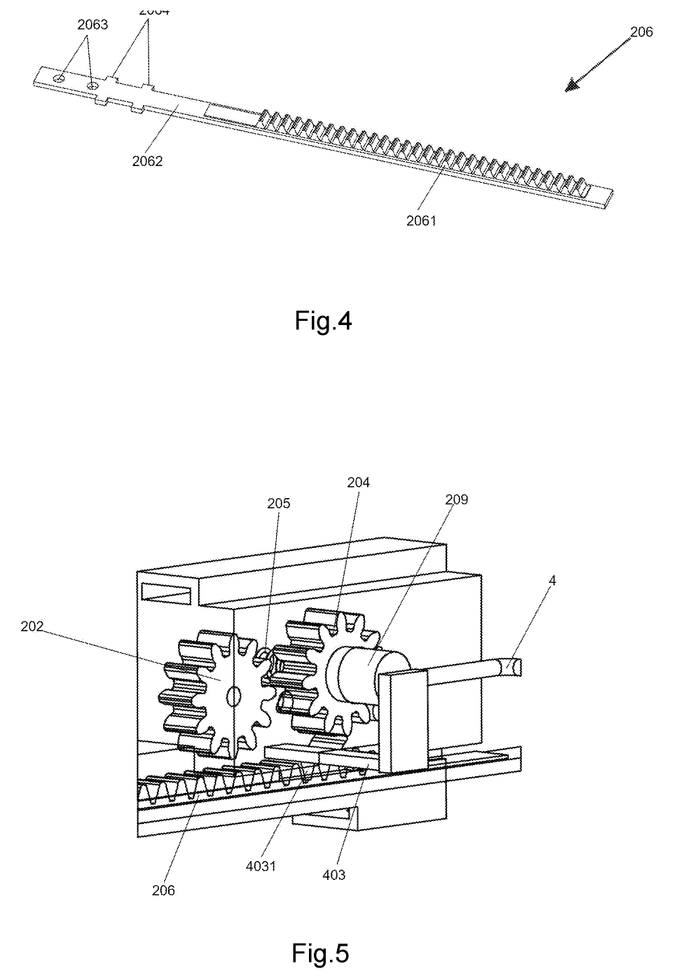

Referring to FIG. 4, the transmission assembly 2 can have a rack 206, which can have a toothed section 2061 and an extending section 2062 adjacent to the toothed section 2061 without teeth. The rack 206 can engage with the teeth on the toothed section 2061 of the driven gear 203. When the driven gear 203 rotates, it can drive the rack 206 to move linearly back and forth. A connecting feature, here a connecting hole 2063, can be disposed on the extending section 2062, for example, at its free end. The rack 206 can be connected to a corresponding antenna device via a transmission mechanism (not shown) through its connecting hole 2063, so that when the rack 206 moves, the state or position of the device can be changed, thereby causing a desired change in its performance. An axial fixing feature, here four lateral protrusions 2064, can also be disposed on the extending section 2062.

Referring to FIG. 2, the lateral protrusions 2064 can fix the engagement of the scale stop 207 on one end (lower end) of the extending section 2062, so that the movement of the rack 206 can synchronously drive the scale stop 207 to move together. The scale 208 can pass through the other end (upper end) of the scale stop 207 and can be guided therein to move relative to the scale stop 207. The scale stop 207 can axially stop the stop end 2081 on the left side (inner side) of the scale 208, so by pulling the scale 208 outwards (antenna housing) until the stop end 2081 of the scale 208 stops at the scale stop 207, the position of the rack 206 and thus the corresponding device can be manually viewed from the outside. A restoring spring 209 can be set to automatically push back the scale 208 pulled outwards after releasing it. That is, when the scale 208 is pulled outwards, the stop portion 2082 on the scale 208 compresses the restoring spring 209 towards the guide 210. When the scale 208 is released, the restoring spring 209 pushes the scale 208 back to the position shown in FIG. 2. The guide 210 can be fixed relative to the base 201 or configured as part of it. The rack 206 is disposed in parallel with the scale 208.

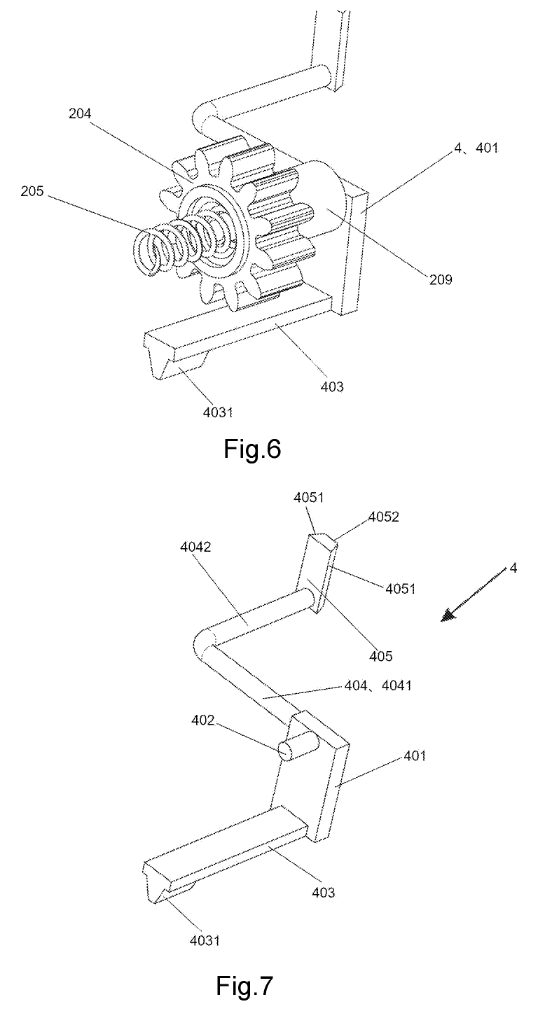

Referring to FIG. 3, FIG. 5, and FIG. 6, the clutch gear 204 can have a connecting post 209 coaxially and fixedly disposed on its side opposite the decoupling spring 205, which can rotate together with the clutch gear 204.

Referring to FIG. 5, FIG. 6, and FIG. 7, the phase shifting system 1 can have a phase shifting transmission element 4 assigned to each transmission assembly 2, specifically to its clutch gear 204, which can be configured as a phase shifting link herein. The phase shifting transmission element 4 can convert the clutch gear 204 from the decoupled position to its coupled position. The phase shifting transmission element 4 is not limited to the form of a phase shifting link in the current example, as long as it can convert the clutch gear 204 from the decoupled position to its coupled position. The phase shifting transmission element 4 has a plate-like pushing section 401 at the end near the clutch gear 204, which can extend perpendicular to the axis of the clutch gear 204 and can move towards the clutch gear 204 to convert the clutch gear 204 from the decoupled position to its coupled position. The phase shifting transmission element 4 can be provided with a connecting pin 402 extending along the axis of the clutch gear 204 on its pushing section 401 (see FIG. 7), which can be inserted into a suitable receiving hole (not shown) in the connecting post 209 on the clutch gear 204. In the coupled position, the clutch gear 204 can drive the connecting post 209 to rotate around the connecting pin 402.

The phase shifting transmission element 4 can have a stop section 403 adjacent to the pushing section 401 (see FIG. 7), which can extend parallel to the axis of the clutch gear 204 on the same side as the connecting pin 402. Referring to FIG. 6, the stop section 403 can be disposed on the radial outer side (herein the lower side) of the clutch gear 204, and a stop tooth 4031 can be provided on the side facing away from the clutch gear 204. Referring to FIG. 5, in the decoupled or initial position of the clutch gear 204, the stop tooth 4031 of the stop section 403 can engage with the teeth of the rack 206, thereby preventing undesirable movement of the rack 206 by the phase shifting transmission element 4, which might otherwise lead to undesired performance changes of the corresponding device. When the phase shifting transmission element 4 pushes the clutch gear 204 from the decoupled position to the coupled position, the stop tooth 4031 of the stop section 403 can simultaneously disengage from the teeth of the rack 206, allowing the driven gear 203 to drive the rack 206 to move.

The phase shifting transmission element 4 can have an intermediate connecting rod section 404, which can be configured in an L-shape. The connecting rod section 404 can thus have a first connecting rod section portion 4041 extending perpendicular to the axis of the clutch gear 204 and a second connecting rod section portion 4042 extending parallel to the axis of the clutch gear 204. The first connecting rod section portion 4041 can be fixedly connected to the pushing section 401.

The phase shifting transmission element 4 can have a transmission section 405 arranged away from the clutch gear 204, which can be wedge-shaped and thus have two opposing transmission slopes 4051 that converge towards each other in the direction away from the connecting rod section 404, and an engagement end face 4052 extending between the transmission slopes 4051 and facing away from the connecting rod section 404.

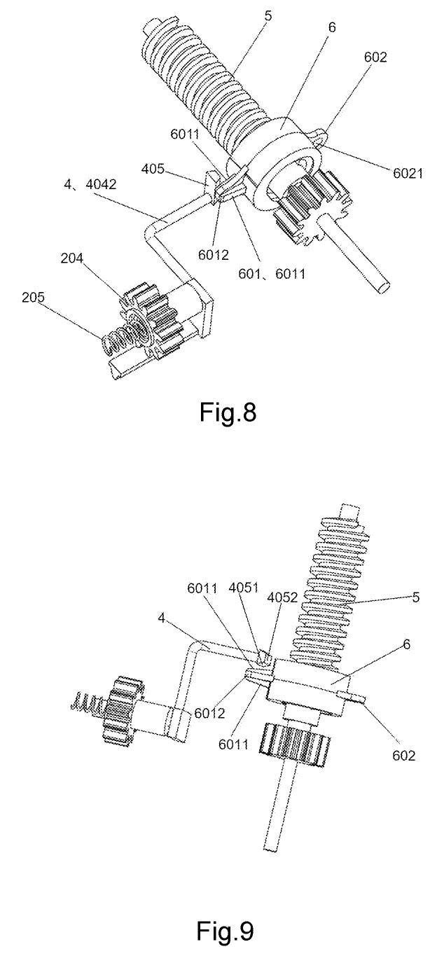

Referring to FIGS. 8 and 9, the phase shifting system 1 can comprise a phase shifting drive mechanism for selectively driving the phase shifting transmission element 4, which can comprise a phase shifting screw 5 and a cooperating phase shifting nut 6. The rotation of the phase shifting screw 5 can be converted into horizontal reciprocating movement of the phase shifting nut 6 on it. The phase shifting screw 5 and the second connecting rod section portion 4042 of the phase shifting transmission element 4 can be arranged perpendicular to each other. The phase shifting nut 6 can have a driving protrusion 601 on its lateral side, which can be wedge-shaped and thus have two driving slopes 6011 converging towards each other in the direction of the transmission section 405 of the phase shifting transmission element 4, and a holding end face 6012 extending between the driving slopes 6011 and towards the engagement end face 4052. When the phase shifting nut 6 moves forward or backward through the transmission section 405 of the phase shifting transmission element 4, the driving slopes 6011 can press the transmission slopes 4051, thereby pushing the entire phase shifting transmission element 4 towards the clutch gear 204, moving the clutch gear 204 from the decoupled position towards the coupled position. When the phase shifting nut 6 moves to the point where the holding end face 6012 of the driving protrusion 601 abuts against the engagement end face 4052 of the transmission section 405, the clutch gear 204 overcomes the force of the decoupling spring 205 and enters its coupled position, allowing the rack 206 to start moving and thus begin adjusting the position and performance of the corresponding device. After the adjustment is completed, the phase shifting nut 6 can continue to move until the holding end face 6012 of the driving protrusion 601 leaves the engagement end face 4052 of the transmission section 405, allowing the clutch gear 204 to return to its decoupled position under the restoring force of the decoupling spring 205, thereby stopping the movement of the rack 206 and ending the adjustment of the performance of the corresponding device.

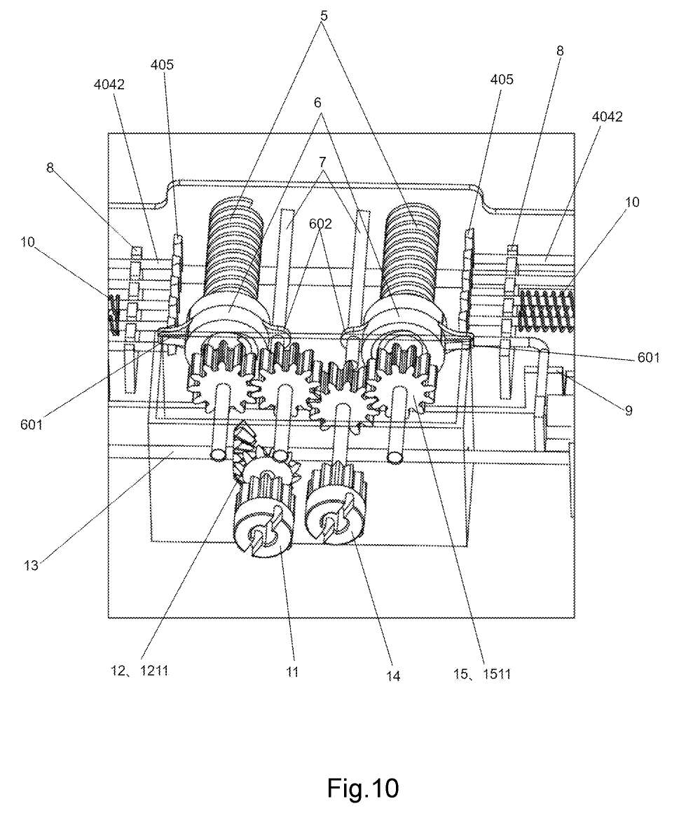

The phase shifting nut 6 may have a guide protrusion 602 on the side opposite the driving protrusion 601, which can have a guide hole 6021. Referring to FIG. 10, a guide rod 7 can pass through the guide hole 6021 to guide the phase shifting nut 6.

Referring to FIGS. 1 and 10, in this first example of the phase shifting system 1, two phase shifting screws 5 are arranged parallel to each other and axially aligned, with a phase shifting nut 6 on each phase shifting screw 5. The two guide protrusions 602 of the two phase shifting nuts 6 are arranged facing each other on the inside, each guided by a corresponding guide rod 7. The two phase shifting nuts 6 have driving protrusions 601 on their outer sides facing away from each other. These two driving protrusions 601 can be aligned with each other in a direction perpendicular to the phase shifting screws 5.

Referring to FIGS. 1 and 10, the phase shifting system 1 is provided with five transmission assemblies 2 on each side of the phase shifting screws 5, each equipped with a phase shifting transmission element 4. Each transmission assembly 2 is successively arranged parallel to the phase shifting screws 5. On each side, the five phase shifting transmission elements 4 are successively disposed with their transmission sections 405 alongside the phase shifting screws 5 in a direction parallel to the phase shifting screws 5, and these transmission sections 405 are equidistant from the phase shifting screws 5. The transmission sections 405 of the five phase shifting transmission elements 4 on one side are staggered relative to the transmission sections 405 of the five phase shifting transmission elements 4 on the other side in a direction parallel to the phase shifting screws 5. On each side, the second connecting rod section portion 4042 of the five phase shifting transmission elements 4 can be stopped in a common stop 8, herein a stop plate, which is disposed in succession in five grooves near the transmission section 405. The stop 8 or its grooves can guide the movement of the second connecting rod section portion 4042 and thus the entire phase shifting transmission element 4 towards or away from the clutch gear 204, and prevent lateral displacement of the transmission section 405 when pressed by the driving protrusion 601 of the phase shifting nut 6. For the second connecting rod section portion 4042, which is longer due to the greater distance of the transmission assembly 2 from the phase shifting screw 5, multiple stops 8 can be successively arranged in its extending direction. Additionally, a support 9, herein a support plate, can be provided for each first connecting rod section portion 4041 of the connecting rod section 404, ensuring that the first connecting rod section portion 4041 and the entire connecting rod section 404 are arranged horizontally, facilitating the force translation of the phase shifting transmission element 4 when pressed by the phase shifting screw 5. Additionally, an auxiliary spring 10 can be optionally disposed for the second connecting rod section 4042 of each connecting rod section 404. This auxiliary spring 10 can assist the decoupling spring 205 on the clutch gear 204 in overcoming frictional forces to return the clutch gear 204 to the decoupled position. Specifically, when the phase shifting nut 6 presses the phase shifting transmission element 4, converting the clutch gear 204 from the decoupled position to the coupled position, the auxiliary spring 10 is compressed. When the phase shifting nut 6 moves away from the phase shifting transmission element 4, the clutch gear 204 and the phase shifting transmission element 4 can return to the initial position based on the restoring force of the decoupling spring 205 and the auxiliary spring 10. The auxiliary spring 10 can be disposed similarly to the restoring spring 209.

Thus, when the phase shifting nut 6 moves on the phase shifting screw 5, based on the lateral compression of the transmission slope 4051 by the driving slope 6011, the phase shifting nut 6 can successively move its driving protrusion 601 through the transmission sections 405 of each phase shifting transmission element 4. Consequently, the phase shifting nut 6 can be moved and remain at any of the phase shifting transmission elements 4, thereby moving the phase shifting transmission element 4 and thus the clutch gear 204 together, overcoming the restoring force of the decoupling spring 205 and the auxiliary spring 10, so that the clutch gear 204 moves from the decoupled position to the coupled position, initiating the movement of the rack 206 of the transmission assembly 2. Once the rack 206 has moved to the desired position, the phase shifting nut 6 moves away from the phase shifting transmission element 4 on the phase shifting screw 5. The corresponding clutch gear 204 and phase shifting transmission element 4 then move in reverse under the restoring force of the decoupling spring 205 and the auxiliary spring 10, causing the clutch gear 204 to move from the coupled position back to the decoupled position, thereby stopping the movement of the rack 206. The stop tooth 4031 of the stop section 403 of the phase shifting transmission element 4 engages the rack 206 to hold it in place.

Referring to FIG. 1 and FIG. 10, the phase shifting system 1 can comprise a transmission motor interface 11 for connecting a transmission motor (not shown). This transmission motor interface 11 can drive a common drive shaft 13 via a gear set 12, here a pair of helical gears 1211. The drive shaft 13 can serially connect all 10 driving gears 202 of the transmission assemblies 2, allowing all 10 driving gears 202 to rotate together when the drive shaft 13 turns. However, since only one gear set of the transmission assembly 2 can be engaged by the phase shifting nut 6 at the same time, the other 9 driving gears 202 are effectively idling, which is permissible here.

The phase shifting system 1 can also comprise a phase shifting motor interface 14 for connecting a phase shifting motor (not shown). This phase shifting motor interface 14 can synchronously drive two phase shifting screws 5 via a phase shifting gear set 15, here four spur gears 1511, causing the two phase shifting nuts 6 to move synchronously in the same direction.

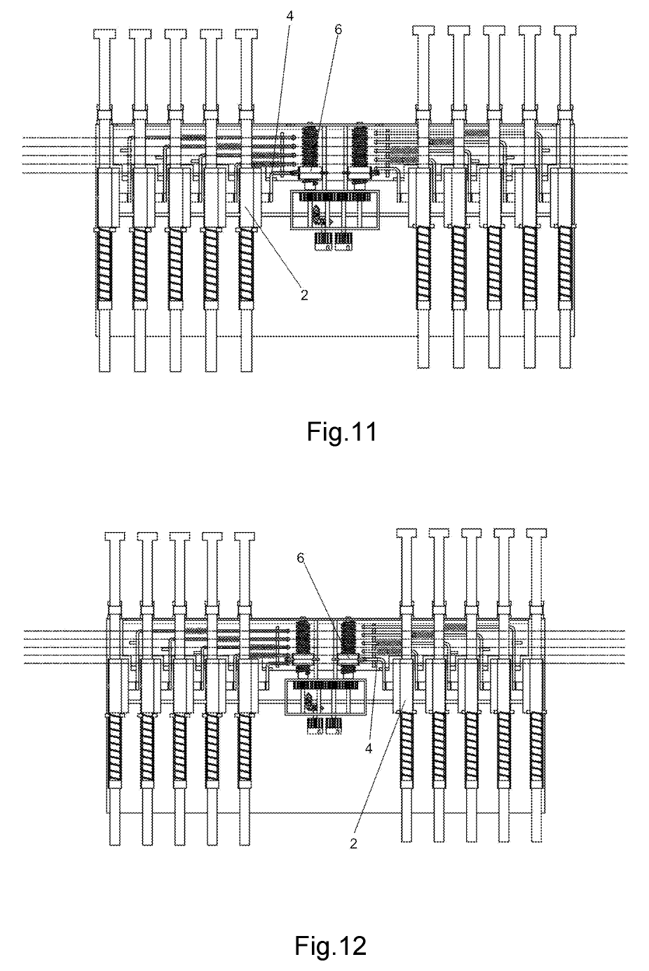

FIG. 11 and FIG. 12 respectively show states where two different transmission assemblies 2 are activated or engaged. In FIG. 11, the first phase shifting transmission element 4 on the left or its transmission section 405 is pressed to the left and held in place by the left phase shifting nut 6. At this time, the clutch gear 204 of the corresponding transmission assembly 2 enters the coupled position, and the rack 206 of the phase shifting assembly moves to adjust the performance of the corresponding device. In FIG. 12, the first phase shifting transmission element 4 on the right or its transmission section 405 is pressed to the right and held in place by the right phase shifting nut 6. At this time, the clutch gear 204 of the corresponding transmission assembly 2 enters the coupled position, and the rack 206 of the phase shifting assembly moves to adjust the performance of the corresponding device. Similarly, the phase shifting nut 6 can move to any of the remaining eight phase shifting transmission elements 4 or their transmission sections 405 to activate the corresponding transmission assembly 2.

It is apparent that in the phase shifting system 1 of the first example of the present disclosure, more transmission assemblies 2 can be successively extended on either side or both sides of the phase shifting system 1 adjacent to the outermost transmission assembly 2. This only increases the lateral dimension of the phase shifting system 1 (the left-right width in the drawings and, if necessary, the up-down length for arranging the transmission sections 405) but does not increase its height (perpendicular to the plane of the paper).

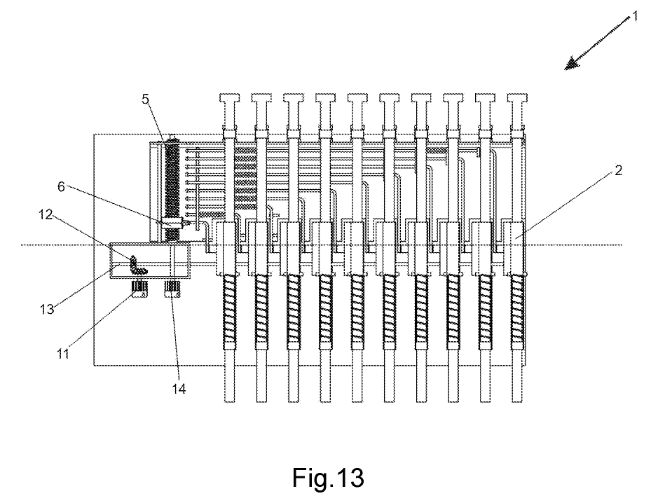

FIG. 13 shows the phase shifting system 1 of the second example of the present disclosure, differing from the first example in that all 10 transmission assemblies 2 are disposed on the same side (right side) of the phase shifting screw 5, with no transmission assemblies 2 on the other side (left side). Therefore, only a pair of phase shifting screws 5 and phase shifting nuts 6 are needed here to achieve phase shifting. Additionally, the phase shifting gear set 15 in the first example can be omitted, as the phase shifting motor interface 14 can be directly connected to the main shaft of the only phase shifting screw 5.

Similarly, in the phase shifting system 1 of the second example of the present disclosure, more transmission assemblies 2 can be successively extended on the right side adjacent to the outermost transmission assembly 2. This also only increases the lateral dimension of the phase shifting system 1 (the left-right width in the drawings and, if necessary, the up-down length) but does not increase its height (perpendicular to the plane of the paper).

The present disclosure may include any features or combinations of features disclosed herein implicitly or explicitly, not limited to any defined range listed above. Any element, feature, and/or structural arrangement described herein may be combined in any suitable manner.

The specific examples disclosed above are merely exemplary, and it is apparent to those skilled in the art benefiting from the teachings herein that the present disclosure can be modified and implemented in different but equivalent ways. Therefore, it is clear that changes and modifications can be made to the specific examples disclosed above, and all such variations are considered to fall within the scope and spirit of the present disclosure.

What is claimed is:

1. A phase shifting system for antennas, characterized in that the phase shifting system comprises:
a plurality of transmission assemblies, each of which has a gear set and a rack that can be driven by the gear set, the gear set having a clutch gear that can switch between a coupled position and a decoupled position, wherein in the coupled position of the clutch gear, the gear set can drive the rack to move, and in the decoupled position of the clutch gear, the rack cannot be driven by the gear set;
a plurality of phase shifting transmission elements, each of which is correspondingly disposed to the clutch gear of the plurality of transmission assemblies and can be movably coupled with the clutch gear; and
a phase shifting drive mechanism configured to selectively drive any one of the plurality of phase shifting transmission elements, wherein, the driven phase shifting transmission element can drive the clutch gear of the corresponding transmission assembly from the decoupled position to the coupled position.

2. The phase shifting system according to claim 1, characterized in that the gear set further comprises a driving gear and a driven gear, the driven gear engaging with the rack, wherein, in the coupled position of the clutch gear, the clutch gear engages with the driving gear and the driven gear, and in the decoupled position of the clutch gear, the clutch gear is disengaged from the driving gear and the driven gear.

3. The phase shifting system according to claim 1, characterized in that each phase shifting transmission element is capable of pushing the clutch gear along its axis with its pushing section to move it from the decoupled position to the coupled position, and each clutch gear is provided with a decoupling spring, the decoupling spring being configured to move the clutch gear from the coupled position to the decoupled position by means of its restoring force.

4. The phase shifting system according to claim 1, characterized in that each phase shifting transmission element is provided with a stop tooth, and in the decoupled position of the clutch gear, the stop tooth engages with the teeth of the rack to prohibit the rack from moving.

5. The phase shifting system according to claim 1, characterized in that the rack has a toothed section with teeth and an extending section adjacent to the toothed section without teeth, a scale stop is fixed on the extending section of the rack and can move together with the rack.

6. The phase shifting system according to claim 1, characterized in that the phase shifting drive mechanism comprises at least one pair of cooperating phase shifting screw and phase shifting nut, the rotation of the phase shifting screw being able to drive the phase shifting nut thereon to move, wherein, the phase shifting nut has a driving protrusion laterally, and each of the plurality of phase shifting transmission elements has a transmission section, the transmission sections being arranged successively in the longitudinal direction of the phase shifting screw such that during the movement of the phase shifting nut, the driving protrusion of the phase shifting nut can successively load the transmission sections of the phase shifting transmission elements and thereby driving the phase shifting transmission elements.

7. The phase shifting system according to claim 6, characterized in that each transmission section of the phase shifting transmission elements has a transmission slope and an engagement end face, the driving protrusion being able to move the phase shifting transmission element by pressing the transmission slope, so that the phase shifting transmission element pushes the corresponding clutch gear from the decoupled position to the coupled position, and the driving protrusion can maintain the position of the phase shifting transmission element by abutting against the engagement end face, thereby keeping the clutch gear in the coupled position.

8. The phase shifting system according to claim 7, characterized in that each of the plurality of phase shifting transmission elements has a connecting rod section connected to the transmission section, the connecting rod section having a portion extending perpendicular to the longitudinal direction of the phase shifting screw, the portion of the connecting rod section being laterally stopped by a stop.

9. The phase shifting system according to claim 8, characterized in that a spring is provided for at least one portion of the connecting rod section of the phase shifting transmission elements, the spring being able to apply a restoring force to the phase shifting transmission element towards the direction of the phase shifting screw when the corresponding phase shifting transmission element is driven.

10. The phase shifting system according to claim 6, characterized in that two pairs of phase shifting screws and phase shifting nuts are provided, and the two phase shifting screws are disposed in parallel, wherein a row of transmission assemblies is respectively arranged on the outer sides of the two phase shifting screws, the transmission sections of the two rows of transmission assemblies being arranged successively in the longitudinal direction of one phase shifting screw and being able to be driven by one phase shifting nut respectively.

11. The phase shifting system according to claim 10, characterized in that the transmission sections of the two rows of transmission assemblies are arranged successively offset from each other in the longitudinal direction of the phase shifting screw.

12. The phase shifting system according to claim 10, characterized in that the two phase shifting screws can be synchronously driven by a phase shifting gear set.

13. The phase shifting system according to claim 6, characterized in that a pair of phase shifting screws and phase shifting nuts is provided, a row of transmission assemblies being disposed on one side of the phase shifting screw, the transmission sections of this row of transmission assemblies being arranged successively in the longitudinal direction of the phase shifting screw and being able to be driven by the phase shifting nut.

14. The phase shifting system according to claim 2, characterized in that a common drive shaft is provided for all transmission assemblies, the drive shaft serially connecting the driving gears of all transmission assemblies and being able to simultaneously drive all the driving gears to rotate together.

15. The phase shifting system according to claim 3, characterized in that the pushing section of each phase shifting transmission element has a connecting pin extending along the axis of the clutch gear, the connecting pin being able to be inserted into a receiving part of a connecting post fixed on the clutch gear, wherein in the coupled position, the clutch gear drives the connecting post to rotate around the connecting pin.

16. The phase shifting system according to claim 5, characterized in that the rack is provided with a connecting structure on its extending section, the rack being connected to the antenna device to be adjusted through the connecting structure.
